(19) United States
(12) Patent Application Publication
(10) Pub. No.: US 2015/0194031 A1
(43) Pub. Date: Jul. 9, 2015

(54) Digital Swimmer Safety System

(71) Applicant: Aquatic Safety Concepts LLC, Cumming, GA (US)

(72) Inventors: David M. Cutler, Redding, CT (US); Eric Lee Ferguson, Coram, NY (US); Christopher J. Allen, SR., West Hartford, CT (US); Paul E. Taylor, Redding, CT (US); Thomas F. Healy, Redding, CT (US); Timothy Corcoran Repp, Barkhamsted, CT (US); Michael Dennis Tetreault, Broad Brook, CT (US); Michael Andrew Daigle, Glastonbury, CT (US)

(21) Appl. No.: 14/408,996

(22) PCT Filed: Apr. 8, 2014
(86) PCT No.: PCT/US2014/033256

§ 371 Date: Dec. 18, 2014

Related U.S. Application Data
(63) Continuation of application No. 29/472,065, filed on Nov. 8, 2013.
(60) Provisional application No. 61/809,477, filed on Apr. 8, 2013.
(60) Provisional application No. 61/901,027, filed on Nov. 7, 2013.

(51) Int. Cl. G08B 21/02

(52) U.S. Cl. CPC G08B 21/02

(57) ABSTRACT

A digital swimmer safety system has a programmable radio communications device, such as a smart phone, in communication with a personal radio transmitter on a swimmer. The communications device established a digital connection with the radio transmitter and starts a timer if the signal is lost. The signal may be lost due to submergence of the transmitter in water. If the timer exceeds a threshold, then an alert is displayed. The communications device is configured to continue monitoring the swimmer in background mode so that the user of the device can run another app. The system can be configured so that multiple swimmers can be monitored by the same communications device and different threshold times can be set for each swimmer depending upon their swimming ability.

### TECHNICAL FIELD

This invention relates to swimmer safety devices.

### BACKGROUND ART

There is a long felt need for a device to warn when a person is in danger of drowning.

FIG. 1 is a reproduction 110 of the cover page figure of U.S. Pat. No. 4,549,169 “Personal Ocean Security System” (Moura). Said cover page figure is surrounded by a dotted line. The item numbers presented within said dotted line are from Moura. One or more of said item numbers will be referred to herein as appropriate. Moura describes a system for providing an indication when a person 22, falls into the water. Said person wears a radio transmitter 26 which is monitored by a base station 28. In the event that said person falls into the water, the radio transmissions from the transmitter is extinguished and an appropriate alarm is generated by said base station. Moura, however, is not suitable for monitoring the safety of a skilled swimmer engaged in recreational swimming since said person is normally in the water and the radio transmissions from Moura's transmitters would always be extinguished thus providing false alarms.

U.S. Pat. No. 6,157,303 “Water Safety Portable Transmitter and Receiver” (Bodie) describes a radio transmitter worn on a person. Said transmitter is illustrated in FIG. 1 of Bode and identified therein as item 10. Said transmitter comprises a capacitance water sensor. Said transmitter is worn on a person's wrist. In the event that said person falls into fresh water, the capacitive sensor is triggered and the transmitter broadcasts an alarm signal to a base station that sounds an audible alarm. The device is applicable for monitoring children near a swimming pool.

FIG. 2 shows a portion 200 of a photograph of a small child wearing the Bodie transmitter 202. Unfortunately, the width 204 required for the Bodie transmitter, in combination with its symmetric mounting on a wristband 206 causes pinching 208 when worn on a small child's wrist. Thus the wristband will be uncomfortable and the child will resist wearing it.

FIG. 3 is a reproduction 300 of FIG. 6 of U.S. Pat. No. 5,408,222 “Device for Warning When a Person is Submerged Beneath Water” (Yaffe). The figure is surrounded by a dotted line. The item numbers presented therein are from Yaffe. One or more of said item numbers will be referred to herein as appropriate. Yaffe describes a device for timing when a swimmer's head is above water. The device 10 comprises a water sensitive switch that closes upon immersion and initiates a timer. After a preset period of time, the timer will transmit an alarm signal. The transmitted signal may be a radio signal broadcast from an antennae 27a located at least in part on the side of a person's head. The alarm signal may be picked up by a receiver 21 coupled to an inflatable device 28 that will inflate and bring the swimmer to the surface of the water. In order to be effective, however, the radio transmissions must be at a frequency that will travel through several centimeters of water so that they can trigger inflation when the swimmer is under water too long.

### DISCLOSURE OF INVENTION

The disclosure of invention is provided as a guide to understanding the invention. It does not necessarily describe the most generic embodiment of the invention or all species of the inventions described herein. As used herein, the term “about” or its equivalents means plus or minus 10% of a given value unless specifically indicated otherwise.

FIG. 4 illustrates a Digital Swimmer Safety System 400. The safety system comprises a programmable radio communications device 402 and one or more personal radio transmitters 404, 406 worn either by non-swimmers 403, such as a toddler, or swimmers 405, such as an adolescence child. A personal radio transmitter may be mounted on a wristband 407 for use on a non-swimmer or a headband 409 for use on a swimmer. Wristbands and headbands are collectively referred to herein as “swimbands”. The personal radio transmitters may be in radio communication 408, 410 with the programmable radio communications device. The radio communication may be modulated carrier wave digital communication. Suitable carrier frequencies are those that transmit readily through air but are attenuated at least 5 dBm by a centimeter of water. Frequencies of about 2.4 GHz are suitable. A suitable digital communications protocol for said transmissions is Bluetooth® or ZigBee®. Bluetooth® is a registered US trademark of Bluetooth Sig, Inc. ZigBee® is a registered US trademark of ZigBee Alliance Corporation. Suitable programmable radio communications devices include iPhone® cellular phones, iPad® tablet computers or other Bluetooth® or Zigbee® compatible devices. iPhone® and iPad® are registered US trademarks of Apple Inc. The programmable radio communications device illustrated in FIG. 4 is an iPhone.

The programmable radio communications device may comprise a touch screen 411 for displaying information and receiving user input. It may additionally comprise a speaker for broadcasting sounds, a physical oscillator for transmitting vibrations or a flash for transmitting a bright light. The communications device may further comprise a radio transmitter and radio receiver. The communications device may comprise a microprocessor and a permanent memory wherein said permanent memory comprises computer readable instructions to cause said microprocessor to receive input from an input device (e.g. said touch screen) and transmit output to an output device (e.g. said speaker).

A personal radio transmitter may comprise a microprocessor, a permanent memory (e.g. firmware), a radio transmitter and a radio receiver. The permanent memory may comprise computer readable instructions to cause said microprocessor to receive input from an input device (e.g. said radio receiver) and transmit output to an output device (e.g. said radio transmitter). If said permanent memory comprises firmware, said programming may be performed by physically altering said firmware to comprise said computer readable instructions.

The screen 411 of said communications device may display a current status monitor 412. Said current status monitor may show a color and a number indicating the number of swimbands in radio communication with said device. A green icon may be used to indicate that a swimband is a normal state. A yellow icon may be used to indicate that a swimband is in a warning state. A red icon may be used to indicate that a swimband is in an alert state. A warning state may indicate that a monitored person should be attended to. An alert state may indicate that a monitored person is in need of immediate attention. For a non-swimmer, an alert state may be triggered if the signal from a personal transmitter is lost for 3 seconds or more. For a swimmer, an alert state may be triggered if the signal from a personal transmitter is lost for 20 seconds or more. A warning state for a swimmer may be triggered 10 seconds before an alert state. For a non-swimmer, a warning state may be triggered if said non-swimmer's signal strength slowly decreases over an extended period of time, such as 60 seconds. This may indicate that the non-swimmer wearing the personal radio transmitter is wandering off.

The screen of said communications device may additionally comprise one or more swimband status areas 414. A swimband status area may comprise an icon 422 indicating a swimband's status (e.g. normal, warning, alert), a name 424 for a swimband (e.g. “Wahooo iSwimband 2”), a swimband signal strength indicator 426, a swimband battery indicator 428 and a link 431 to a screen for editing swimband parameters or viewing additional swimband information. “Swimband signal strength” and “swimband battery” refer to the personal radio transmitter located within said swimband.

The screen of said communications device may additionally comprise a link 416 to add an additional swimband to be monitored.

The screen of said communications device may also comprise a link 436 to a monitor screen, a link 434 to a swimband manager screen, and a link 432 to a network screen. These will be explained in more detail below. The screen displayed in FIG. 4 is an exemplary monitor screen.

### TRADEMARK NOTICE

iSwimband® and Wahooo® are registered trademarks of Aquatic Safety Concepts LLC.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BRIEF DESCRIPTION OF DRAWINGS

FIG. 1 displays prior art.

FIG. 2 displays prior art.

FIG. 3 displays prior art.

FIG. 4 displays an exemplary digital swimmer safety system.

FIG. 5A displays a top cross section of an exemplary personal radio transmitter.

FIG. 5B displays a side cross section of the exemplary personal radio transmitter of FIG. 5A.

FIG. 6A displays a front view of an exemplary headband for holding a personal radio transmitter.

FIG. 6B displays a magnified top cross section of the exemplary headband of FIG. 6A.

FIG. 6C displays a magnified side cross section of the exemplary headband of FIG. 6A.

FIG. 7A displays a front view of an exemplary clip for holding the straps of a headband.

FIG. 7B displays a top cross section of a clip in use on a headband.

FIG. 8A displays a front view of an exemplary wristband for holding a personal radio transmitter.

FIG. 8B is a top cross section of the wristband of FIG. 8A.

FIG. 9A is a screen shot of an exemplary monitor screen displayed on a programmable radio communications device.

FIG. 9B is a screen shot of an exemplary swimband manager screen.

FIG. 10A is a screen shot of an exemplary confirmation screen.

FIG. 10B is a screen shot of an exemplary swimband manager detail screen.

FIG. 11A is a screen shot of an exemplary detail screen.

FIG. 11B is a screen shot of an exemplary alert screen.

FIG. 12A is a screen shot of an exemplary network sharing screen.

FIG. 12B is a screen shot of an exemplary network connection screen.

FIG. 13A is a screen shot of an exemplary network permission screen.

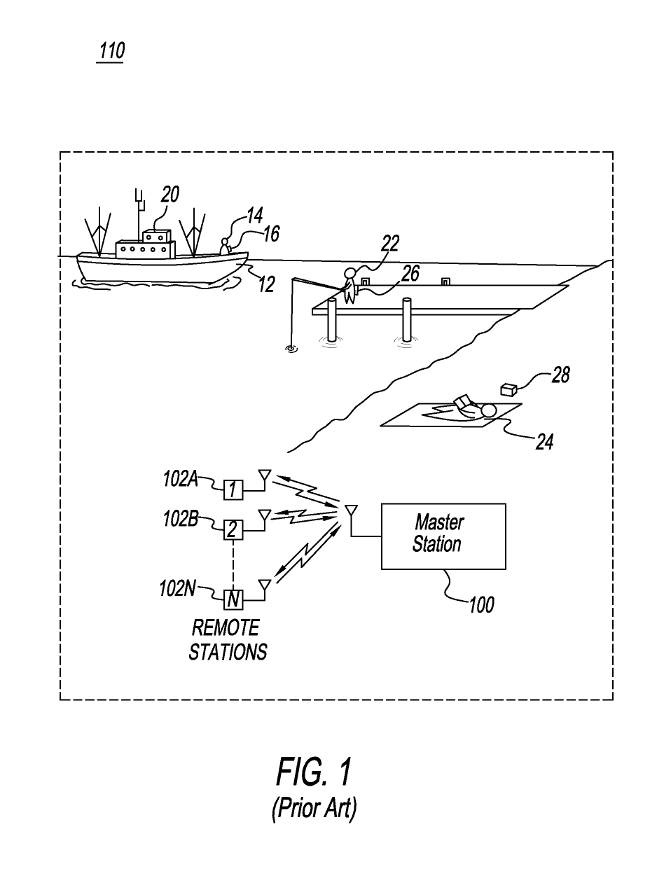

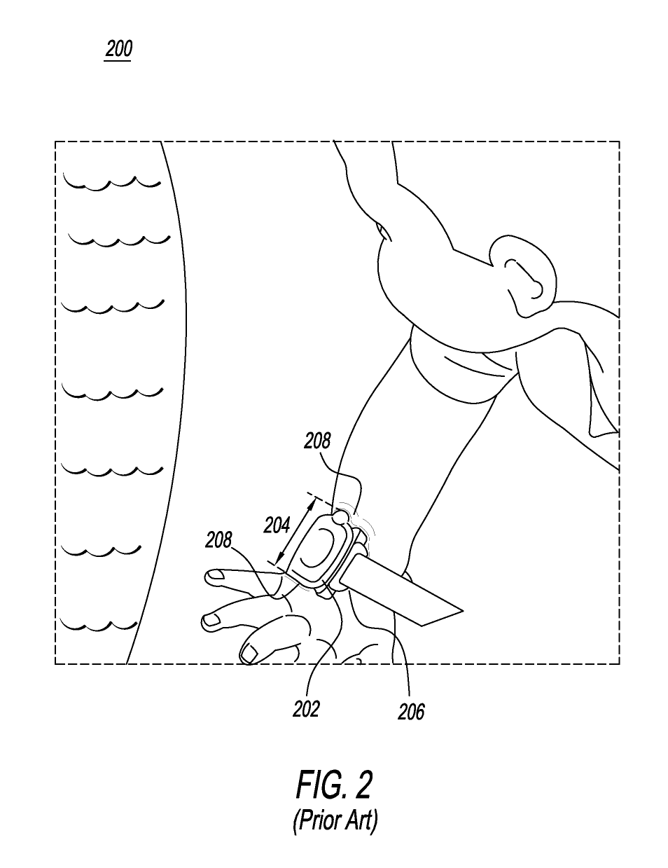

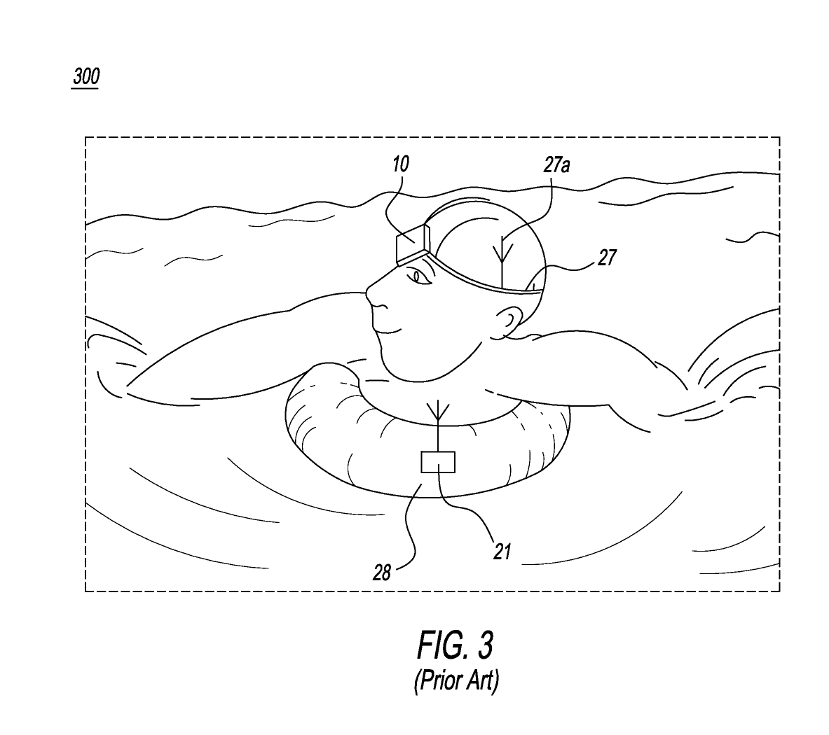

### BEST MODE FOR CARRYING OUT THE INVENTION

The following modes for carrying out the inventions describe various embodiments and features of the inventions. These embodiments and features are meant to be exemplary and not limiting.

### Personal Radio Transmitter

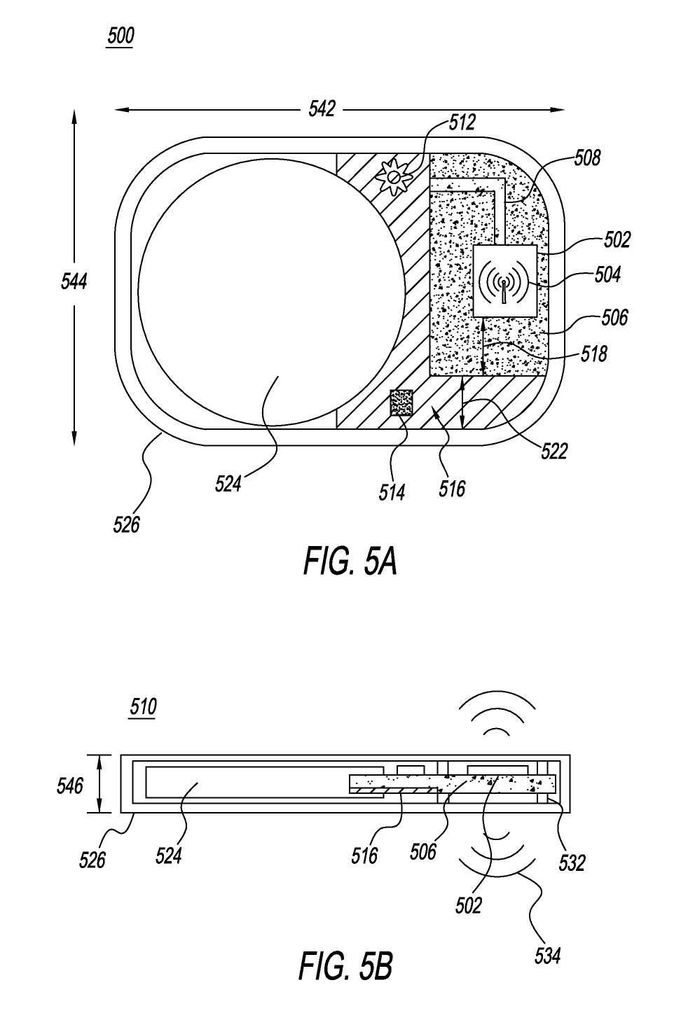

FIG. 5A shows a top cross section view of an exemplary personal radio transmitter 500. Said transmitter comprises a programmable two way radio communications device 502. Suitable two-way radio devices include a Broadcom® BCM20732 BLE-only System-On-Chip (SoC) and a Texas Instruments® CC2540 SoC. Broadcom® is a registered trademark of Broadcom Inc. Texas Instruments® is a registered trademark of Texas Instruments Inc. The two-way radio device may comprise an integral radio antenna 504, such as a Planar Inverted f Antennae (PIFA).

Said radio device may be mounted on a circuit board 506. Said circuit board may comprise a partial ground plane 516. A minimum width 522 of the ground plane may be provided to improve the range of said antenna. A suitable width is about 3-4 mm. A minimum spacing 518 may be provided between said radio device and said ground plane to improve the range of said antenna. A suitable spacing is about 2-3 mm.

Said transmitter may comprise additional devices such as a light emitting diode (LED) 512 and an accelerometer 514. The accelerometer may be a three axis accelerometer. The LED may provide an indication that the transmitter is on. The accelerometer may be used to turn the transmitter on or off. The accelerometer may turn the transmitter on with a double tap and/or with a rotation. The accelerometer may turn the transmitter off if no motion above a minimum threshold is detected for an extended period of time, such as 10 minutes. An “off state” may comprise a sleep mode wherein said two way communications device maintains minimal functionality, such as receiving input from said accelerometer to turn on.

Said radio device may be connected to said additional devices by conductors 508 routed through said circuit board. Said circuit board may be a multi-layer board, such as a four layer board. The range of said radio antenna may be enhanced if said conductors are constrained to a path about 1 mm wide before they reach the ground plane.

Power may be provided to said transmitter by a battery 524. Said battery may be a coin cell such as a Duracell® DL2032. Duracell® is a registered trademark of The Gillette Company Corporation. A rechargeable battery may alternatively be provided with recharging means, such as an inductively coupled charger.

Said personal radio transmitter may comprise a case 526. Said case may be made of plastic. Said case may be hermitically sealed by, for example, ultrasonic welding.

FIG. 5B is a side cross section 510 of the personal radio transmitter of FIG. 5A. Pins 532 are provided to elevate the circuit board so that the plane of said antenna is about the same as the plane of a surface of said battery. With the combination of the above described layout, it was discovered that the range 534 of communication of said personal radio transmitter with an iPhone was at least 30 meters in open air.

The two-way radio device 502 may have three operation modes: sleep, connected and advertising. Sleep mode for the Broadcom SoC described above consumes about 1.5 pA. Connected mode consumes about 0.07843 mA. Advertising mode consumes about 0.244 mA. While not wishing to be bound by this explanation, the difference in current draw between advertising mode and connected mode may be related to the relative frequency of the digital packet broadcasts from the two-way radio device. Advertising packets may be broadcast on a period of less than 0.5 ms since the radio device is seeking to make a connection. Connection packets may be broadcast on a period of about 200 ms since a connection has been made. A 200 ms period for connection packets is suitable for personal water safety device.

After a connection is made, the two-way radio device will remain in connected mode when it is above water and communicating with a programmable communications device. Said two-way device will revert to advertising mode when it is out-of-range of said communications device. Out-of-range includes being submerged in water.

It is desirable to have a battery life of at least one year. A swimmer that swims on a routine basis may use a swimband 720 hours per year. The personal radio communications device may be in connected mode for 288 hours and in advertising mode 432 hours due to said swimmer constantly placing his/her head in water. This corresponds to a total current consumption of 0.14 Amp-hours, including current used during sleep mode. A CR2032 battery is rated at 0.23 Amp-hours.

It is additionally desirable to have a personal radio transmitter that is thin. A CR2032 meets this criteria with a thickness of about 3 mm. This leads to a battery diameter requirement of about 2 cm in order to have enough volume and hence energy capacity.

The combination of battery size, ground plane and circuit board size requirements can be accommodated by a case with a length 542 of about 3.8 cm, a width 544 of about 2.5 mm and a thickness 546 of about 0.5 cm. Improved battery technologies and/or improved two-way device power efficiencies and antenna requirements may allow for smaller personal transmitters.

### Headband Design

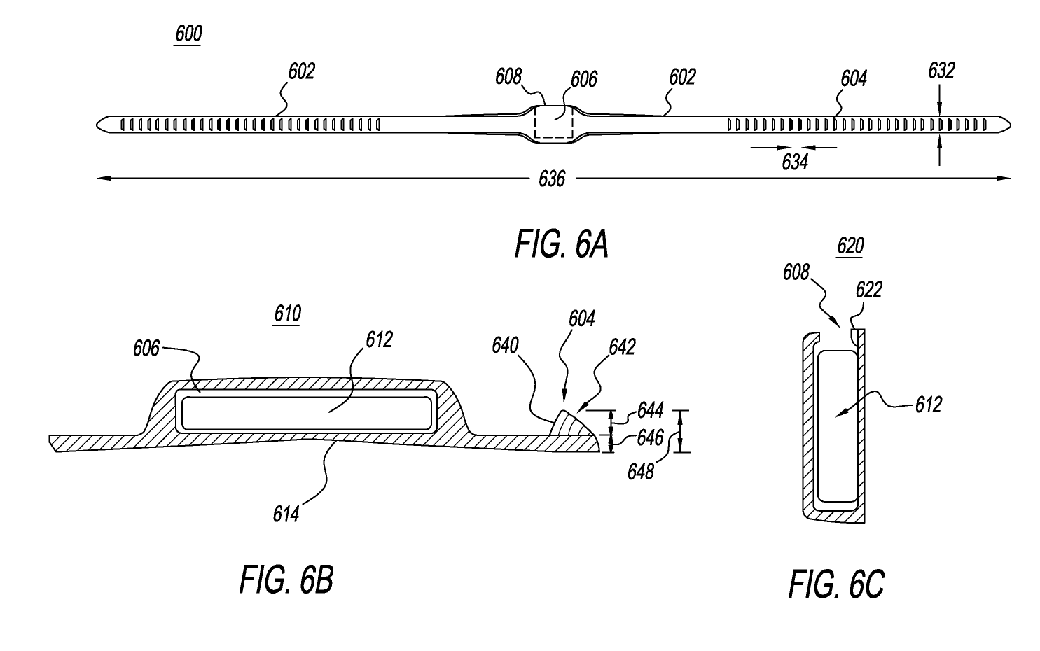

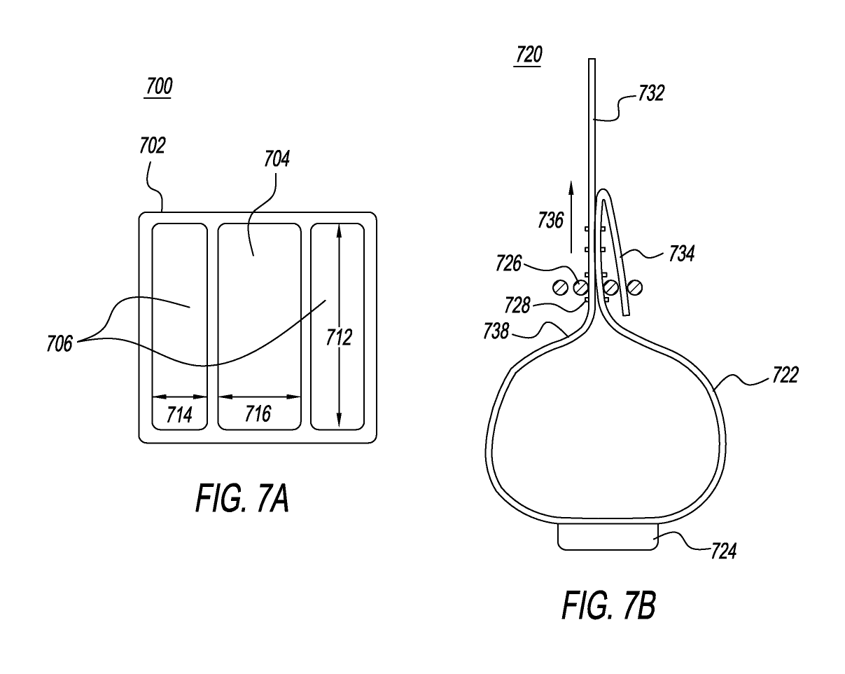

FIGS. 6A, 6B and 6C show a front view 600, magnified top cross section view 610 and magnified side cross section view 620 of an exemplary headband. Referring to FIG. 6A, the headband 600 comprises straps 602 and a central pocket 606. The straps comprise a series of bumps 604. The central pocket has an open top 608 for receiving a personal radio transmitter therein. A suitable length 636 of a headband is about 66 cm. A suitable width 632 of a strap is about 1.2 cm. A suitable thickness 646 (FIG. 6B) of a strap is about 0.225 cm. A suitable height of a bump 644 (FIG. 6B) is about 0.025 cm. This will give a combined strap plus bump thickness 648 of about 0.25 cm. A bump may have a gradual leading slope 642 and a steep trailing slope 640. A suitable angle for said leading slope is about 25 degrees with respect to the horizontal. A suitable angle for said trailing slope is about 60 degrees with respect to the horizontal. As discussed in more detail below, said slopes in combination with the clip described in FIG. 7A will help make the headband easy to adjust yet stable in a set position. A suitable spacing 634 (FIG. 6A) between bumps is about 0.65 cm.

Referring to FIG. 6B, a personal radio transmitter 612 is shown inside the pocket 606. A concave curvature 614 is shown at the back of said pocket to help the head strap conform to the curvature of a person's forehead. A suitable radius of curvature is about 16.5 cm.

Referring to FIG. 6C, a lip 622 is shown at the top opening 608 of the pocket. Said lip helps to hold the personal transmitter 612 in said pocket. Thus a swimmer can play vigorously in the water without the transmitter falling out.

A suitable material of construction for said headband is a water compatible elastomer. Silicone rubber is a suitable elastomer.

Numerous other designs for the head strap are possible. For example, fabric straps with appropriate clips may be used. The personal transmitter can be permanently molded into the head band or attached to the headband by clips, Velcro® or other closures. Velcro® is a registered trademark of Velcro Industries B. V. The personal radio transmitter and/or battery can also be placed on the back or side of a swimmer's head, provided that the broadcasting antenna is mounted on the front of said swimmer's head. Mounting the antenna on the front of a person's head is required since the indicator of a swimmer being in distress is that his/her mouth and nose are submerged for an unsafe period of time.

### Clip Design

FIG. 7A is a front view of a clip 700. Said clip comprises interconnected bars 702 which form a center opening 704 and two side openings 706. Said bars may have a diameter of about 0.2 cm. The material of construction should be stiff. Rigid plastic is a suitable material of construction. The internal length of said openings 712 is about equal to or greater than the width of the corresponding straps 602 (FIG. 6A) that will be placed through them. An opening length of about 1.3 cm is suitable for a strap width of about 1.2 cm. A suitable width 714 of a side chamber is about the same as the combined thickness of a strap and a bump. A width of about 0.25 cm is suitable for a combined strap thickness plus bump height of 0.25 cm. This will allow a strap to slide through with minor catching as each bump passes through the opening. The width 716 of the center opening should be slightly less than twice the combined thickness of a strap and bump. A width of about 0.48 cm is suitable for a combined thickness of two straps and bumps of 0.5 cm. 10% is considered to be slightly less. The reduced width of the center opening will allow straps to be pulled through for adjustment with modest force but help lock the straps in place once sideways tension is placed on them. This is illustrated in FIG. 7B.

FIG. 7B shows a top cross sectional view 720 of a clip 726 holding the straps of a headband 722. The headband is wrapped around a person's head (not shown) with the pocket holding the personal radio transmitter 724 resting on said person's forehead. The ends of the two straps 732, 734 are placed back-to-back and pulled 736 through the center opening of the clip. The user pulls the clip up to the back of his/her head until the fit is snug. This is facilitated by the gradual slope of the leading edge of the bumps. Once in position, the strap exerts a sideways force 738 which, in combination with the steep slope of the trailing edge of the bumps 728, holds the clip in place. The user may then thread one or more straps 734 through its corresponding outer opening in the clip. For removal, the headband may be simply slid off of the user's head with the clip remaining in position, or the straps may be removed from their side openings and the clip slid back.

### Wristband Design

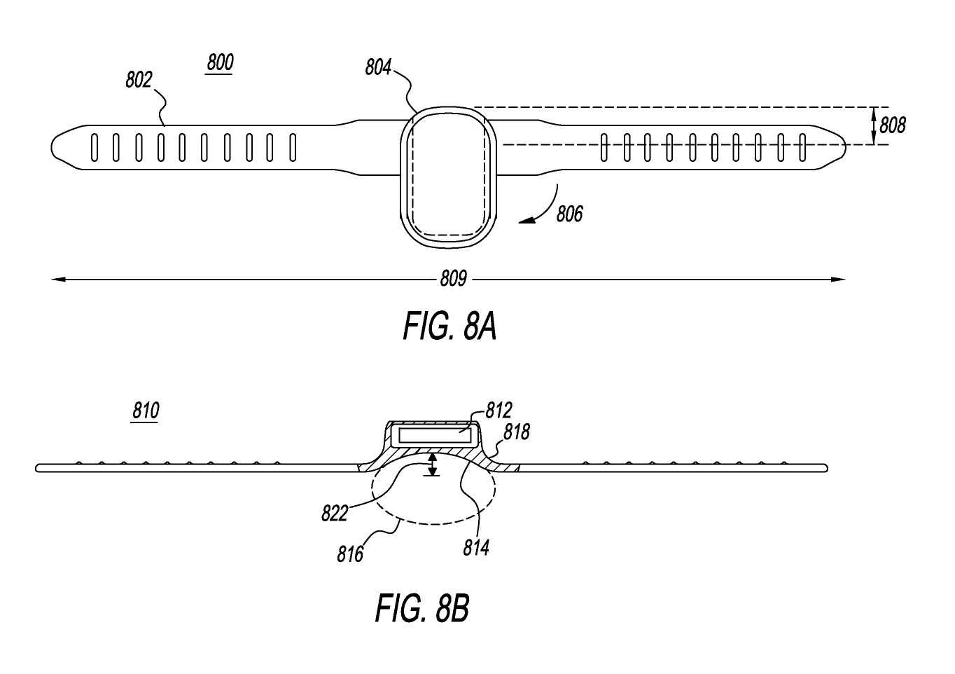

An exemplary wristband design 800 is illustrated in FIG. 8A. This is a front view. Similar to the headband, the wristband comprises straps 802 and an open top center pocket 804 for holding a personal radio transmitter. The straps may have a similar design to a corresponding headband. This will allow the use of the same clip for both a head band and a wristband provided in the same consumer package.

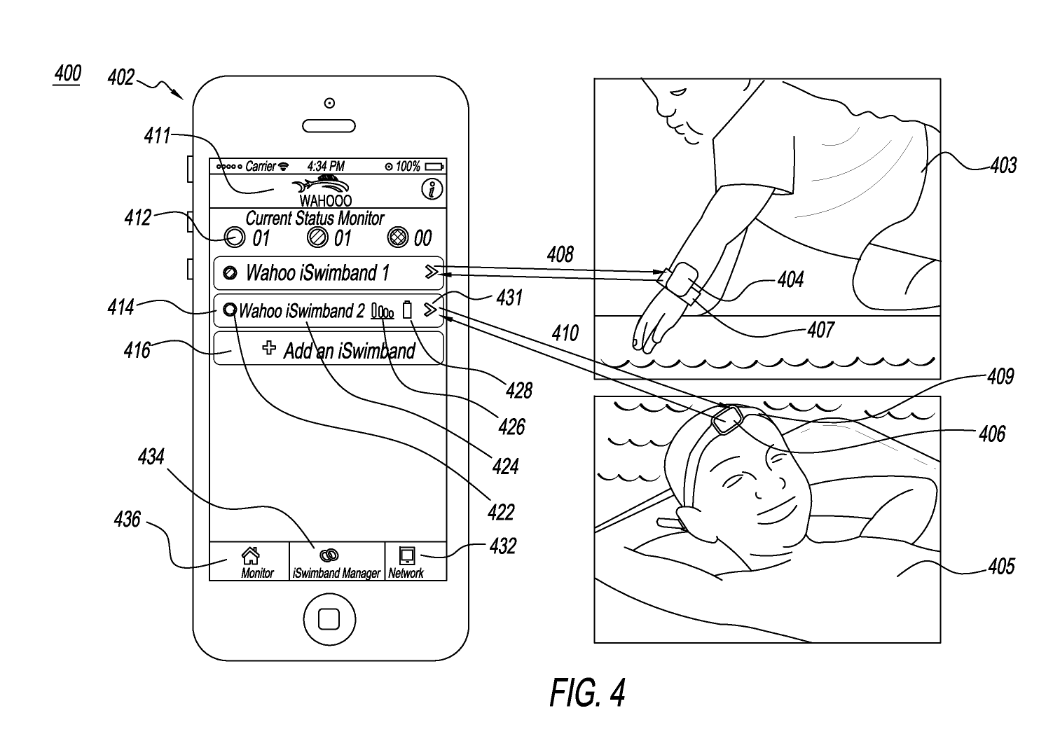

A suitable overall length 809 of the wristband is about 23 cm. The dimensional requirements of the personal radio transmitter described herein make it unwieldy for the pocket to have the same orientation on a wristband as it has on a headband. It was surprisingly discovered that it if the pocket on a wristband was rotated 90 degrees (806) and shifted off center so a first side of the pocket 804 was about 1.3 cm from the centerline 808 of the strap, that a toddler could wear the wristband without the transmitter causing pinching or other undue discomfort when the toddler flexed his/her hand about his/her wrist. See the personal transmitter 404 and wristband 407 mounted on the crawling toddler in FIG. 4. Thus the wristband pocket configuration allows the same personal transmitter to be used in both a wristband designed for a toddler and a headband designed for an adolescent or adult.

An additional advantage of the rotated orientation of the personal transmitter pocket is that once the personal transmitter is inserted, the deeper pocket makes the transmitter difficult to remove. Thus a toddler is unlikely to be able to remove the transmitter from the pocket. The clip design also makes it difficult for a toddler to remove the wristband once the straps are adjusted and put through their respective side openings. Thus a wristband made according to the guidance provided herein may be secured on a small child without the need for a key-based locking mechanism.

FIG. 8B shows a side cross section 810 of the wristband of FIG. 8A. A personal radio transmitter 812 is shown in the pocket. There is a concave surface 814 in the back of the pocket. A suitable radius of curvature is about 1.3 cm. This corresponds to the radius of curvature of a small child's wrist 816. Relatively stiff wings 818 are provided on the sides of the pocket to extend the curvature to a depth 822 of about 0.55 cm. This will help the band conform to a small child's wrist.

Suitable materials of construction for the wristband include water compatible elastomers. Silicone rubber is a suitable elastomer. The durometer of the elastomers used may be similar to the durometers of other aquatic devices such as goggle straps and wristbands. Alternative materials of construction such as those described for the headband may also be used.

### Modes of Operation and User Interfaces

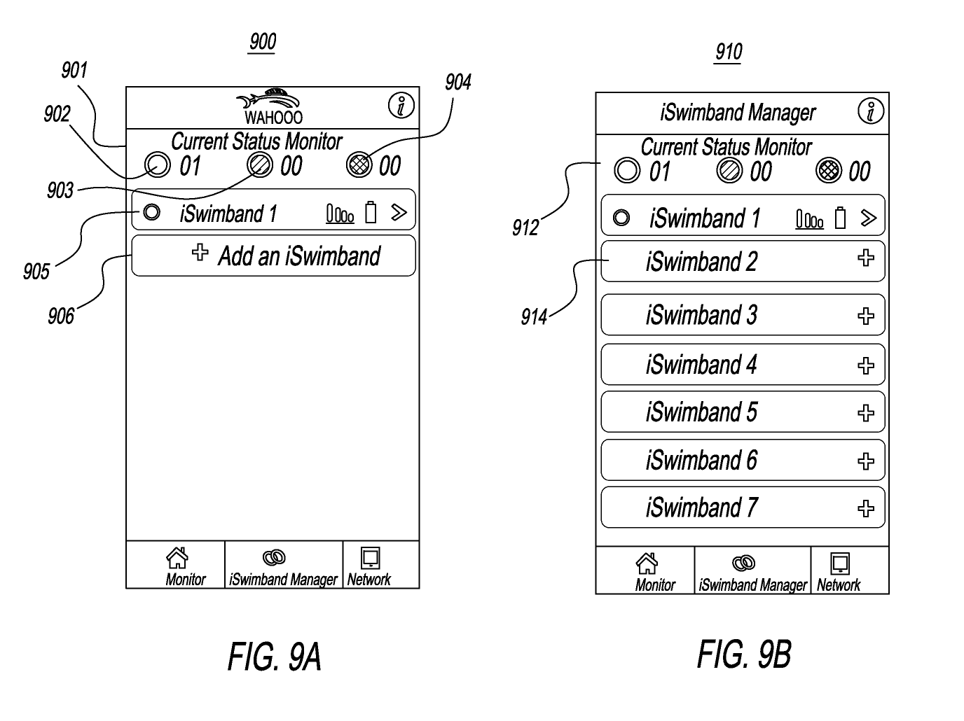

Exemplary modes of operation and user interfaces are illustrated in FIGS. 9A through 13A. Said figures are screen shots of user interfaces presented on an iPhone. The iPhone in these examples is serving as a programmable radio communications device. Similar screen designs and functionality may be provided on similar programmable radio communications devices that allow for foreground and background operation of apps, such as Android® devices, Window® devices and Ubuntu® devices. Android® is a registered US trademark of Google Inc. Windows® is a registered US trademark of Microsoft Inc. Ubuntu® is a registered US trademark of Canonical Limited.

FIG. 9A shows a monitor screen 900 that is currently monitoring swimband “iSwimband 1” 905. The collective status of the monitored swimbands is shown in the current status monitor 901. The leftmost icon 902 is green and shows that the one monitored swimband is in a normal state. The center icon 903 is yellow and indicates that no monitored swimbands are in a warning state. The rightmost icon 904 is red and indicates that no monitored swimband are in an alert state.

Provision 906 is made for the user to add a swimband to be monitored. If the user selects this option via, for example, touching it on the iPhone touchscreen, then a swimband manager screen 910 (FIG. 9B) is presented.

FIG. 9B illustrates a swimband manager screen. The current status monitor 912 is still presented indicating that swimbands are still being monitored. There are, however, additional local swimbands that are in advertising mode that the communications device can monitor. These are indicated by labeled areas 914. If a user wishes to monitor one of these swimbands, then the user selects the band to be monitored.

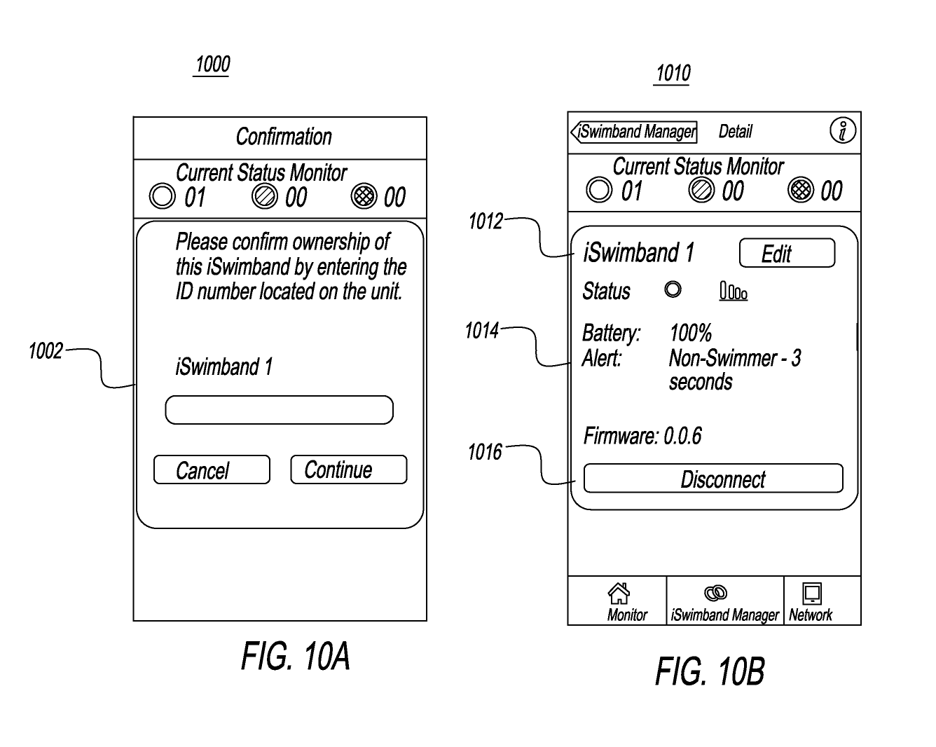

FIG. 10A shows an exemplary confirmation screen 1000 presented to a user upon selecting a swimband. The user is asked to input a confirmation code 1002. Said confirmation code, for example, may be a 6 digit code associated with a particular personal transmitter. If the user inputs the correct code, then the programmable communications device responds to the advertising signal and establishes a connection with the corresponding swimband. This connection comprises relatively low power handshake messages transmitted back and forth from the personal transmitter to the communications device.

The system may be configured to require that the user input the confirmation code for the particular swimband selected. Alternatively, the system may be configured to determine if the code input by the user corresponds to any of the advertising swimbands. If so, the system may inform the user of the name of the swimband selected.

FIG. 10B shows a swimband manager detail page 1010 that is presented once the connection with a swimband is established. The user may edit the name of the swimband 1012. The user may also be presented with information 1014 about the swimband. The user may be presented with an option 1016 to disconnect from a swimband. If the user disconnects from a swimband, the swimband returns to an advertising state.

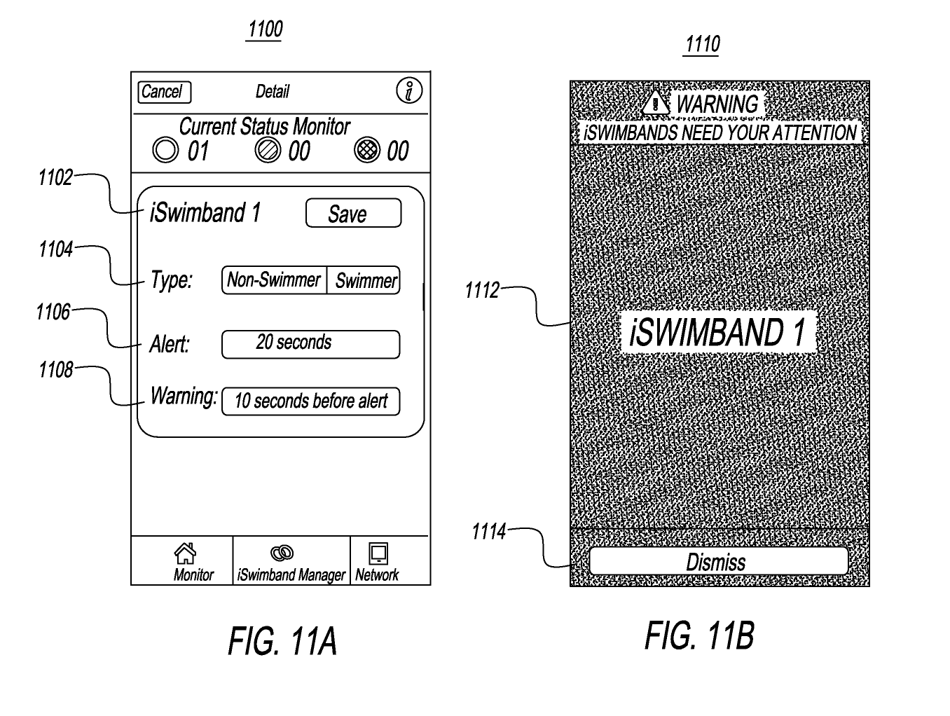

FIG. 11A illustrates a swimband edit screen 1100 that may be presented to a user. The user may edit the name 1102, type of swimmer 1104, time period at which an alert is sounded 1106 and time period preceding an alert when a warning should be indicated 1108. A suitable default time period for an alert for a non-swimmer is 3 seconds. A suitable default time period for a swimmer is 20 seconds. A user may be provided with the option to have longer or shorter time periods before an alert is sounded. Suitable warning should be provided to the user, however, if the user selects longer periods than the defaults. The warnings may require a specific action by the user to override a default, such responding to a warning that says “Are you sure?”

FIG. 11B shows an exemplary alert screen 1110 that may be displayed in the event that a connection signal from a monitored swimband is lost by the programmable radio communications device for longer than said swimband's alert period. The alert needs to be dramatic and persistent 1112 since a person may be in immediate danger. The alert may include one or more of a loud noise transmitted through the speakers of the communications device, a bright flashing light transmitted through a flash on said device or a vibration transmitted through a physical oscilator on said device. Notwithstanding the above, provision 1114 may be provided to dismiss an alert.

### Foreground and Background Requirements

Many programmable radio communications devices allow a user to switch from one application (app) to another. This will allow the user to switch from a swimband app to another app provided the swimband app still has certain functionality while the user is engaged in the new app. An app that a user switches from is termed to be “in the background”. Different operating systems allow for different levels of functionality of apps that are in the background. At a minimum, the operating system for the communications device running a swimband app must:
Recognize when the connection signal is broken with a connected swimband;
Initiate a timer once the connection is broken;
If said timer exceeds the alert time period for a swimband, push an alarm to one of the output peripherals of a device, such as a visual indication on a screen, a loud noise to a speaker, a flashing light to a camera flash, or a vibration to a physical oscilator; and
Reconnect to a swimband and reset the swimband's timer if the communications device receives said swimband's advertising signal.

The Apple iOS6 and iOS7 operating systems have this minimum functionality. Thus these systems will continue to monitor swimbands and provide an alert even if the user switches to another app after launching the Swimband app.

### LAN Connectivity

Many programmable radio communications devices are able to connect wirelessly to a local area network (WiFi LAN). This functionality allows multiple users to monitor the same swimband. A swimband may only be able to communicate directly with a single communications device, but said communication device may relay said swimband's status to other authorized communications devices through said WiFi LAN.

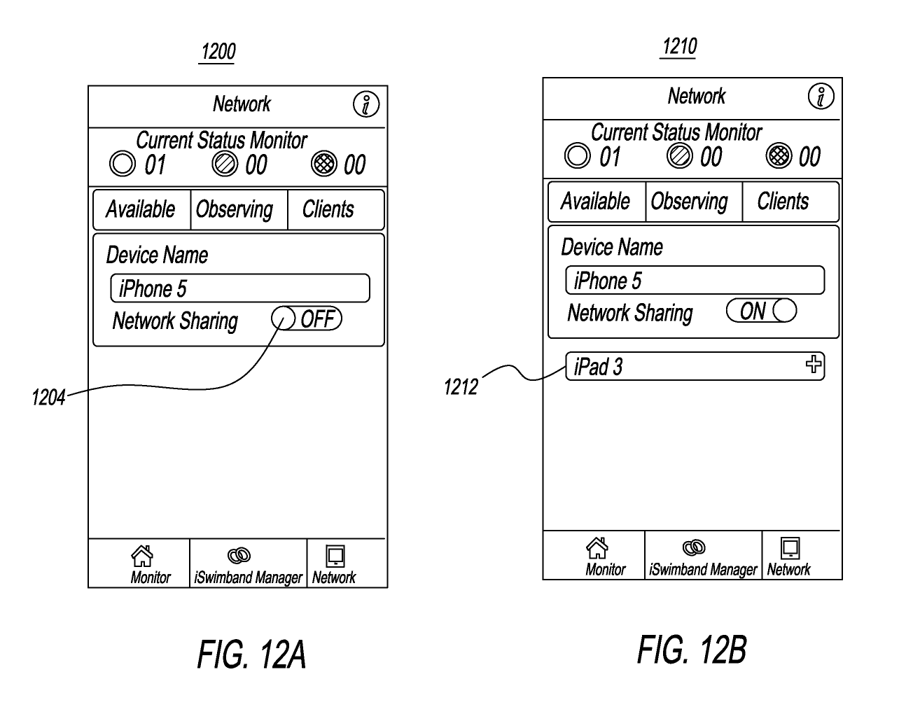

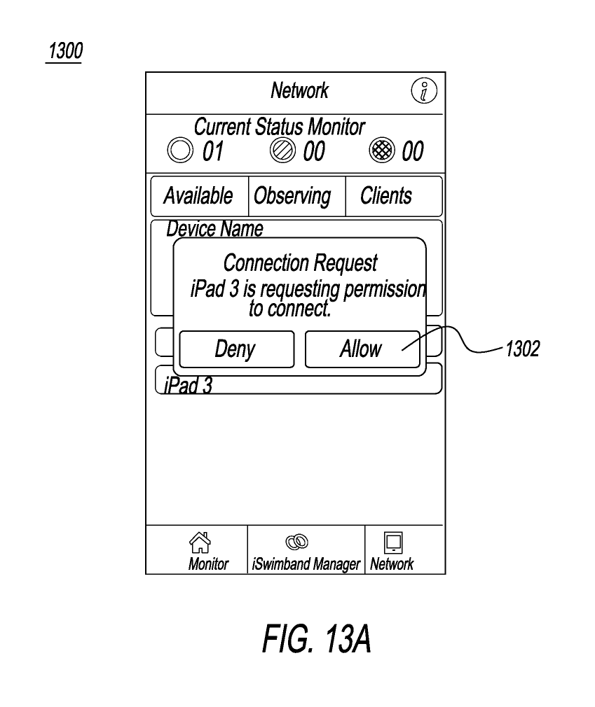

FIG. 12A presents an exemplary screen 1200 used to initiate LAN sharing of a monitored swimband's status. A first user observes that his/her network sharing is off. If the user activates network sharing by sliding button 1204, for example, then screen 1210 (FIG. 12B) may be presented. This screen displays other personal radio communications devices 1212 that are connected through the same LAN and are running the appropriate swimband app. The user of the other communications device may then request connection 1300 (FIG. 13A) to the first user. If the first user allows said connection 1302, then the second user will see the status of the first user's monitored swimbands. Similarly, the first user may request to see the status of the second user's monitored swimbands. This provides an extra degree of redundancy of notification of alerts.

Having thus described a presently preferred embodiment of the present invention, it will be understood by those skilled in the art that many changes in construction and circuitry and widely differing embodiments and applications of the invention will suggest themselves without departing from the scope of the present invention as defined in the claims. The disclosures and the description herein are intended to be illustrative and are not in any sense limiting of the invention, defined in scope by the following claims. Any features described herein may be combined with any other feature to provide the benefits indicated for each feature.

What is claimed is:

1. A digital swimmer safety system comprising a first programmable radio communication device and a first personal radio transmitter wherein:
a) said first programmable radio communication device comprises:
i) a first radio transmitter;
ii) a first radio receiver;
iii) a display device;
iv) a first microprocessor;
v) a first permanent memory comprising computer readable instructions to physically cause said first programmable radio communication device to carry out the monitoring steps of:
1) receiving a first digital advertising signal from said first personal radio transmitter;
2) establishing a first connection with said first personal radio transmitter in response to said receiving of said first advertising signal;
3) initiating a first timer in the event that said first connection is lost;
4) outputting an alert to said display device in the event that said first timer exceeds or equals a first alert time; or
5) resetting said first timer in the event that a second advertising signal is received from said first personal radio transmitter before said first timer exceeds or equals said first alert time; and wherein
b) said first personal radio transmitter comprises:
i) a second radio transmitter;
ii) a second radio receiver;
iii) an antenna;
iv) a switch;
v) a second microprocessor;
vi) a second permanent memory comprising computer readable instructions to physically cause said first personal radio transmitter to carry out the steps of:
1) turning on in response to the activation of said switch;
2) broadcasting via said antenna a modulated carrier wave digital advertising signal in response to being turned on;
3) switching to connected mode when said first programmable radio communication device responds to said advertising signal;
4) switching back to said advertising signal in the event that said connection is broken; and wherein
c) said first programmable radio communications device is configured to run said monitoring steps in background mode such that a user of said communications device may run a different app without interrupting said monitoring; and wherein
d) said carrier wave has a frequency that is attenuated at least 5 dBm per cm of water.

2. The digital swimmer safety system of claim 1 wherein said carrier wave frequency is about 2.4 GHz.

3. The digital swimmer safety system of claim 1 wherein said antenna is mounted on the front of a swimmer's head.

4. The digital swimmer safety system of claim 1 wherein said antenna is mounted on a headband configured to position said antenna on the front of a swimmer's head.

5. The digital swimmer safety system of claim 4 wherein said headband comprises a pocket for receiving said first personal radio transmitter and wherein the back of said pocket has a concave surface with a radius of curvature of about 16.5 cm and wherein said pocket has an open top with a lip to retain said first personal radio transmitter therein.

6. The digital swimmer safety system of claim 1 wherein said first programmable radio communications device further comprises computer readable instructions to cause said first microprocessor to allow a user to select a swimmer mode or a non-swimmer mode such that said first alert time is adjusted according to said selection.

7. The digital swimmer safety system of claim 6 wherein said first alert time for said swimmer mode is about 20 seconds.

8. The digital swimmer safety system of claim 6 wherein said first alert time for said non-swimmer mode is about 3 seconds.

9. The digital swimmer safety system of claim 1 which comprises a second personal radio transmitter configured in the same manner as said first personal radio transmitter and wherein said monitoring steps further comprises steps to monitor said second personal radio transmitter with an associated second timer and second alert time and wherein said first programmable radio communication device will output an alert if either of said first or said second alert times are equaled or exceeded.

10. The digital swimmer safety system of claim 9 wherein said first alert time is different than said second alert time.

11. The digital swimmer safety system of claim 1 which further comprises a second programmable radio communications device and wherein said first communications device and said second communications device are configured to communicate through a WiFi LAN and wherein said first communications device is configured to transmit the status of said first personal radio transmitter to said second radio communications device such that in the event of an alert, said alert will be displayed on said second radio communications device.

12. The digital swimmer safety system of claim 1 wherein said first personal radio transmitter is mounted on a wristband that comprises a strap such that a first side of said first transmitter does not extend more than 1.3 cm beyond the centerline of said strap.

13. The digital swimmer safety system of claim 12 wherein said wristband comprises a pocket for receiving said first personal radio transmitter and wherein the back of said pocket has a concave surface with a radius of curvature of about 1.3 cm and a depth of about 0.55 cm.

14. The digital swimmer safety system of claim 12 which further comprises a clip and wherein said clip comprises a center opening and two side openings and wherein said strap comprises a plurality of bumps and wherein the width of each of said side openings is about the same at the combined thickness of said strap and said bumps and the width of said center opening is less than twice the width of said combined thickness of said strap and said bumps.

15. The digital swimmer safety system of claim 1 wherein said first personal radio transmitter further comprises:
a) a battery;
b) a circuit board; and
c) a ground plane
wherein:
d) said antenna is mounted on said circuit board;
e) said ground plane is between 2 and 3 mm from said antenna; and
f) said antenna is in about the same plane as a surface of said battery.

16. The digital swimmer safety system of claim 1 wherein said switch comprises an accelerometer and wherein said second radio transmitter is configured to begin broadcasting advertising packets when said accelerometer is either tapped or rotated.

17. The digital swimmer safety system of claim 1 wherein said first programmable radio communications device will display a flashing light in response to said first alert.
